(19) United States
(12) Patent Application Publication
(10) Pub. No.: US 2008/0285394 A1
(43) Pub. Date: Nov. 20, 2008

(54) OPTICAL DISC APPARATUS AND METHOD OF PROCESSING SYNCHRONIZATION SIGNAL FOR THE APPARATUS

(75) Inventor: You Yoshioka, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/829,826

(22) Filed: Jul. 27, 2007

(30) Foreign Application Priority Data
Jul. 28, 2006 (JP) 2006/206755

(51) Int. Cl. H04M 11/04

(52) U.S. Cl. 369/44.13

(57) ABSTRACT

An optical disc apparatus includes a reproduction unit that reproduces a wobble signal on an optical disc, the wobble signal having physical address information subjected to phase modulation by using a code sequence that has a predetermined cycle and that is subjected to code modulation in accordance with a modulation rule common to the cycles; a phase detection unit that performs phase detection to the reproduced wobble signal to demodulate the code sequence; an evaluation value calculating unit that sequentially calculates an evaluation value indicating how much the code sequence coincides with the modulation rule in units of codes in the code sequence; an integrator that cyclically integrates the evaluation value in the cycle; and a synchronous detection unit that detects the presence of the code sequence and a reference position of the code sequence from the integrated evaluation value.

### CROSS-REFERENCE TO RELATED APPLICATIONS

This application claims the benefit of priority of Japanese Patent Application No. 2006-206755, filed Jul. 28, 2006, the entire contents of which are incorporated herein by reference.

### BACKGROUND

1. Field

The present invention relates to optical disc apparatuses and methods of processing synchronization signals. More particularly, the present invention relates to an optical disc apparatus that reproduces wobble signals recorded on an optical disc and a method of processing synchronization signals for the optical disc apparatus.

2. Description of the Related Art

Write-once-read-many or rewritable optical discs have sinusoidal spiral grooves provided in advance on the recording surfaces thereof. The grooves, which are called wobbles, serve as guide tracks during recording. Wobble signals having information necessary for recording and reproducing data on the optical discs are modulated.

For example, wobbles having time codes that indicate time information for every sector and that are subjected to frequency modulation (FM modulation) are provided on compact discs-recordable (CD-Rs) and compact discs-rewritable (CD-RWs). This time information is called Absolute Time In Pregroove (ATIP).

The ATIP includes synchronization signals, and it is important to detect the synchronization signals at correct positions. Accordingly, for example, JP-A 2004-5977 discloses a technology for detecting synchronization signals, in which a digital filter is used to perform correct signal detection by using a synchronous demodulation circuit.

Wobbles are also provided on write-once-read-many or rewritable digital versatile discs (DVDs), such as DVD+Rs and DVD+RWs. Physical addresses on the discs are subjected to phase modulation and are recorded on the wobbles on such recording-reproduction DVDs. The recorded information is called Address In Pregroove (ADIP). The ADIP also includes synchronization signals to be detected at correct positions.

In reproduction of the ADIP, wobble clocks having the same basic cycle as that of wobble signals are generated by a phase locked loop (PLL) for the wobble signals and the wobble signals are subjected to the phase detection at the timings of the wobble clocks. The signals subjected to the phase detection are binarized and a synchronization signal having a certain bit pattern is detected from the binarized signals to extract physical address information at predetermined positions from the synchronization signal.

However, in the formats giving priority to the recording density, such as the DVDs, the wobbles have lower degrees of modulation, recording channel signals have frequency allocation similar to that of wobble modulation signals, and the wobbles have higher degrees of interference with adjacent tracks. Consequently, the wobble signals have lower signal-to-noise ratios (SN ratios) and the waveforms of the wobble signals are likely to be distorted.

As a result, there are cases where it becomes difficult to read codes from the wobble signals subjected to the phase detection and misdetection or non-detection of the synchronization signal can occur. The misdetection is an event in which a signal other than the synchronization signal is erroneously detected as a synchronization signal. The non-detection is an event in which the synchronization signal cannot be detected despite of the presence of the synchronization signal.

### SUMMARY OF THE INVENTION

Accordingly, it is an object of the present invention to provide an optical disc apparatus capable of reducing misdetection or non-detection of synchronization signals even if wobble signals reproduced from an optical disc have lower SN ratios to realize stable synchronous detection and to provide a method of processing synchronization signals for the optical disc apparatus.

According to an embodiment of the present invention, an optical disc apparatus includes a reproduction unit that reproduces a wobble signal on an optical disc, the wobble signal having physical address information subjected to phase modulation by using a code sequence that has a predetermined cycle and that is subjected to code modulation in accordance with a modulation rule common to the cycles; a phase detection unit that performs phase detection to the reproduced wobble signal to demodulate the code sequence; an evaluation value calculating unit that sequentially calculates an evaluation value indicating how much the code sequence coincides with the modulation rule in units of codes in the code sequence; an integrator that cyclically integrates the evaluation value output from the evaluation value calculating unit in units of codes in the cycle; and a synchronous detection unit that detects the presence of the code sequence and a reference position of the code sequence from the evaluation value integrated by the integrator.

According to another embodiment of the present invention, an optical disc apparatus includes a reproduction unit that reproduces a wobble signal on an optical disc, the wobble signal having physical address information subjected to phase modulation by using a code sequence that has a predetermined cycle and that is subjected to code modulation in accordance with a modulation rule common to the cycles; a phase detection unit that performs phase detection to the reproduced wobble signal to demodulate the code sequence; an integrator that cyclically integrates the phase detection value output from the phase detection unit in units of codes in the cycle; an evaluation value calculating unit that sequentially calculates an evaluation value indicating how much the code sequence coincides with the modulation rule in units of codes in the code sequence for the integrated phase detection value; and a synchronous detection unit that detects the presence of the code sequence and a reference position of the code sequence from the evaluation value calculated by the evaluation value calculating unit.

According to another embodiment of the present invention, a method of processing synchronization signals for an optical disc apparatus includes the steps of reproducing a wobble signal on an optical disc, the wobble signal having physical address information subjected to phase modulation by using a code sequence that has a predetermined cycle and that is subjected to code modulation in accordance with a modulation rule common to the cycles; performing phase detection to the reproduced wobble signal to demodulate the code sequence; sequentially calculating an evaluation value indicating how much the code sequence coincides with the modulation rule in units of codes in the code sequence; cyclically integrating the evaluation value in the cycle; and detecting the presence of the code sequence and a reference position of the code sequence from the integrated evaluation value.

According to another embodiment of the present invention, a method of processing synchronization signals for an optical disc apparatus includes the steps of reproducing a wobble signal on an optical disc, the wobble signal having physical address information subjected to phase modulation by using a code sequence that has a predetermined cycle and that is subjected to code modulation in accordance with a modulation rule common to the cycles; performing phase detection to the reproduced wobble signal to demodulate the code sequence; cyclically integrating the demodulated phase detection value in the cycle; sequentially calculating an evaluation value indicating how much the code sequence coincides with the modulation rule in units of codes in the code sequence for the integrated phase detection value; and detecting the presence of the code sequence and a reference position of the code sequence from the evaluation value.

According to the optical disc apparatus and the method of processing synchronization signals for the optical disc apparatus according to the embodiments of the present invention, it is possible to reduce misdetection or non-detection of synchronization signals even if wobble signals reproduced from an optical disc have lower SN ratios to realize stable synchronous detection.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an example of the configuration of an optical disc apparatus according to an embodiment of the present invention;

FIGS. 2A and 2B illustrate two wobble signals “PW” and

FIG. 3 illustrates the structures of one ECC block on a DVD+R or a DVD+RW and of an ADIP word in the ECC block;

FIG. 4 illustrates an example of an ADIP pattern common to a “sync unit” and a “data unit”;

FIGS. 5A to 5C show examples of the structures of the first eight wobbles (ADIP) of the “sync unit” and the “data unit”;

FIG. 6 shows examples of the internal configurations of a phase detector and a wobble PLL portion;

FIG. 7 illustrates a concept of a phase detection operation in the phase detector;

FIG. 8 illustrates an operational concept of an evaluation-value calculating process in detail; and

FIGS. 9A and 9B illustrate an effect of integrating evaluation values in an integrator.

### DETAILED DESCRIPTION

An optical disc apparatus and a method of processing synchronization signals for the optical disc apparatus according to embodiments of the present invention will now be described with reference to the attached drawings.

### (1) Optical Disc Apparatus

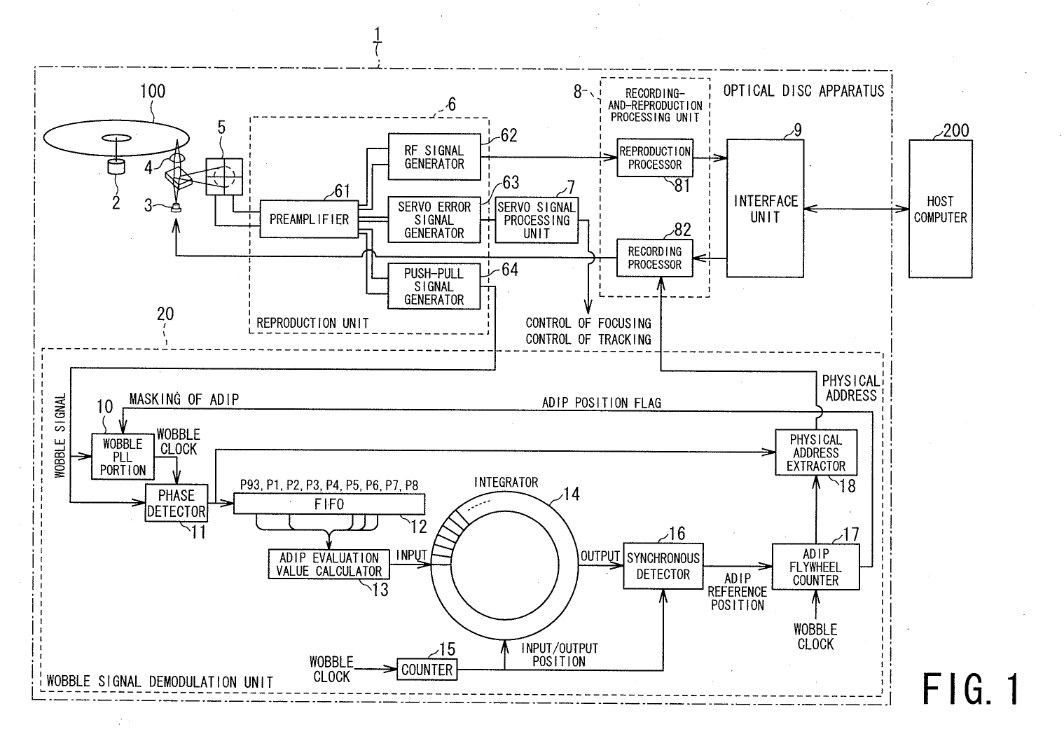

FIG. 1 is a block diagram showing an example of the configuration of an optical disc apparatus 1 according to an embodiment of the present invention.

The optical disc apparatus 1 includes a motor 2, a laser diode 3, an objective lens 4, a photodetector 5, a reproduction unit 6, a servo signal processing unit 7, a recording-and-reproduction processing unit 8, an interface unit 9, and a wobble signal demodulation unit 20. The motor 2 rotates and drives an optical disc 100, such as a DVD+R or a DVD+RW. The recording surface of the optical disc 100 is irradiated with a laser beam emitted from the laser diode 3. The objective lens 4 condenses the laser beam. The photodetector 5 detects a reflected laser beam. The reproduction unit 6 generates, for example, a radio-frequency (RF) signal, a servo error signal, and a wobble signal from the output from the photodetector 5. The servo signal processing unit 7 controls, for example, focusing and tracking. The recording-and-reproduction processing unit 8 performs recording processing, such as code modulation, to recording data output from a host computer 200, in addition to reproduction processing to the RF signal (addition signal). The optical disc apparatus 1 transmits and receives a signal to and from the host computer 200 through the interface unit 9.

The reproduction unit 6 includes a preamplifier 61, an RF signal generator 62, a servo error signal generator 63, and a push-pull signal generator 64. The output signal from the photodetector 5 is amplified into a predetermined signal strength by the preamplifier 61 and part of the amplified output signal is supplied to the RF signal generator 62 to generate an RF signal. The RF signal is supplied to a reproduction processor 81 in the recording-and-reproduction processing unit 8 where, for example, demodulation, decoding of a modulated code, and error correction are performed. The error corrected data is, then, transmitted to the host computer 200 through the interface unit 9.

Part of the output signal from the preamplifier 61 is supplied to the servo error signal generator 63 to generate various servo error signals, such as a focus error signal, a tracking error signal, and a tilt error signal. The servo signal processing unit 7 controls positioning of the objective lens 4 on the basis of the servo error signals.

Part of the output signal from the preamplifier 61 is supplied to the push-pull signal generator 64 to generate a difference signal in a radial direction of the optical disc 100. The difference signal is a signal of a pregroove wobble on the optical disc 100, that is, a wobble signal.

The wobble signal is given by performing phase modulation to physical address information on the optical disc 100 by using a predetermined code sequence. The wobble signal is demodulated by the wobble signal demodulation unit 20 to extract a physical address from the demodulated wobble signal. The extracted physical address is supplied to the recording-and-reproduction processing unit 8 where the physical address is used in recording in a recording processor 82 and reproduction in the reproduction processor 81.

The wobble signal demodulation unit 20 includes a wobble PLL portion 10, a phase detector 11, a first-in first-out (FIFO) memory 12, an ADIP evaluation value calculator (evaluation value calculator) 13, an integrator 14, a counter 15, a synchronous detector 16, an ADIP flywheel counter 17, a physical address extractor 18, and so on.

### (2) Wobble Signal Demodulation Unit

The operation of the optical disc apparatus 1, particularly of the wobble signal demodulation unit 20, having the configuration described above and a method of processing synchronization signals according to an embodiment of the present invention will now be described. The method of processing synchronization signals is performed in the wobble signal demodulation unit 20.

As described above, the wobble signal supplied to the wobble signal demodulation unit 20 usually has a lower SN ratio and, in extreme cases, the wobble signal can be completely buried in the noises.

The optical disc apparatus 1 according to the embodiments of the present invention intends to realize stable detection of a synchronization signal even for such a wobble signal having a lower SN ratio to extract a correct physical address. The optical disc apparatus 1 uses the periodicity of the code sequence used for modulating the wobble signal and a modulation rule in the extraction of the correct physical address.

Before the operation of the wobble signal demodulation unit 20 is described, the code sequence adopted in the optical disc 100, which is a target of the optical disc apparatus 1 according to the embodiment of the present invention, will now be described.

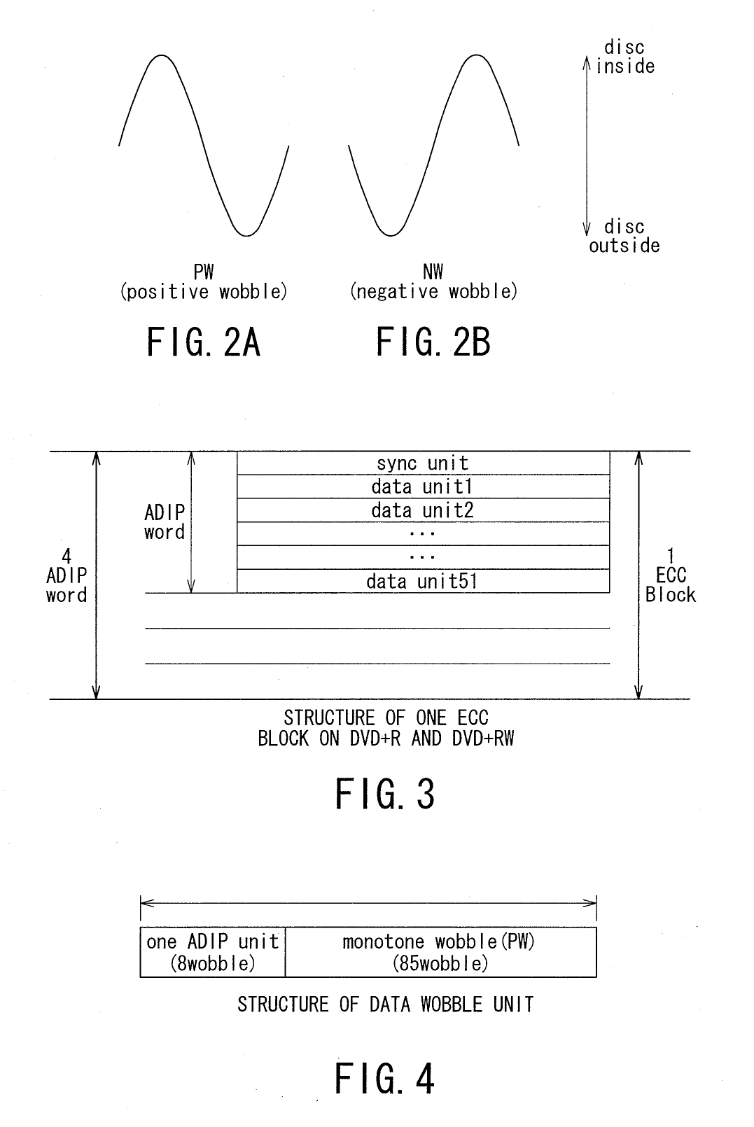

FIGS. 2A and 2B illustrate wobble signals on a DVD+R and a DVD+RW. FIG. 2A indicates the waveform of a positive wobble (PW), which is a monotone wobble. FIG. 2B indicates the waveform of a negative wobble (NW), which is a modulated wobble. The NW has a phase difference of 180° with respect to the monotone wobble. Combination of the PW and the NW represents a synchronization signal and physical address information.

FIG. 3 illustrates examples of the structures of one error correction code (ECC) block and of an Address In Pregroove word (ADIP word) in the ECC block. The ADIP word is one unit to which physical address is allocated. The ADIP word includes 52 units. Among the 52 units, the first “sync unit” indicates synchronization information and the subsequent 51 “data units” indicate information concerning address modulation codes. One unit includes 93 wobbles. The first eight wobbles represent an “ADIP” and the remaining 85 wobbles are monotone wobbles. Accordingly, the ADIP word has 93 wobbles×52 units=4,836 wobbles. The four ADIP words form one ECC block, which is a recording unit.

The “sync unit” and the “data units” are fixed in relative positions on the optical disc 100. Accordingly, determination of the beginning of the ADIP word, that is, the beginning position of the “sync unit” allows the reading timing of the address modulation codes in the subsequent 51 “data units” to be set for every ADIP word.

One ADIP word indicates one physical address and disc auxiliary information, which are given by combination of the address modulation codes in the 51 “data units”. One “data unit” represents data of one bit and one ADIP word can be used to represent 51-bit data.

The physical address information on a DVD+R or a DVD+RW, represented by the ADIP word, has the sum of 51 bits: “reserved” of one bit, “physical address” of 22 bits, “disc auxiliary information” of eight bits, and “error correction code” of 20 bit.

The disc auxiliary information of 32 ADIP words, that is, 32×8 bits=256 bits represents one piece of information. The disc auxiliary information is auxiliary information concerning the optical disc 100. For example, the disc auxiliary information indicates the size of the optical disc 100.

FIG. 4 illustrates an example of an ADIP pattern common to the “sync unit” and the “data unit”.

The first eight wobbles in the “sync unit” and the “data unit” each having 93 wobbles are referred to as an “ADIP”. Part of the “ADIP” is modulated (NW) to represent a synchronization pattern and address modulation codes. All the 85 wobbles following the eight wobbles in the “ADIP” are PWs, which form a non-modulation area.

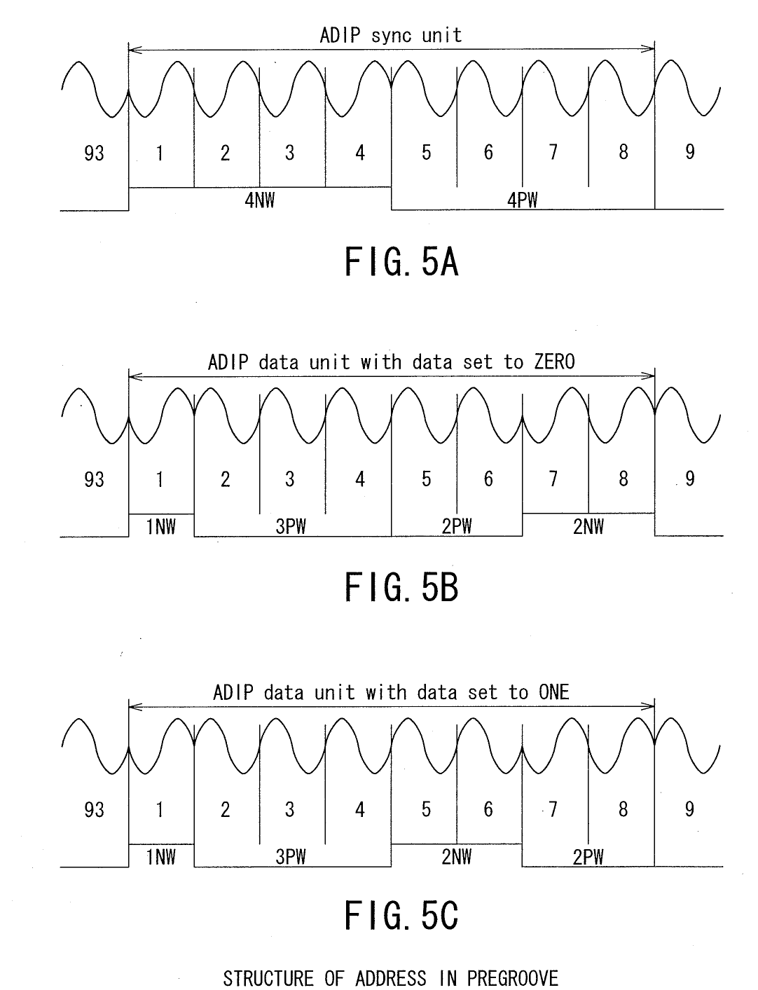

FIGS. 5A to 5C show examples of the structures of the “ADIP” (the first eight wobbles) of the “sync unit” and the “data unit”.

FIG. 5A shows a synchronization pattern of the “sync unit”. In this synchronization pattern, the first four wobbles in the “ADIP” of the “sync unit” are modulated into the NWs and the following four wobbles are monotone PWs.

FIG. 5B shows the “ADIP” in the “data unit” when the data is set to zero (“data 0”). FIG. 5C shows the “ADIP” in the “data unit” when the data is set to one (“data 1”).

The first four wobbles in FIG. 5B are the same as those in FIG. 5C. The first wobble is set to an NW and the following three wobbles are set to PWs in order to discriminate the “ADIP” in the “sync unit” from the ADIP in the “data unit”.

The last four wobbles in the “ADIP” in the “data 0” are different from those in the “data 1”. Specifically, the first two wobbles among the last four wobbles are PWs and the last two wobbles thereamong are NWs in the “data 0”. In contrast, the first two wobbles among the last four wobbles are NWs and the last two wobbles thereamong are PWs in the “data 1”.

The waveforms of the “sync unit” and the “data units” are subjected to the phase detection in the phase detector 11.

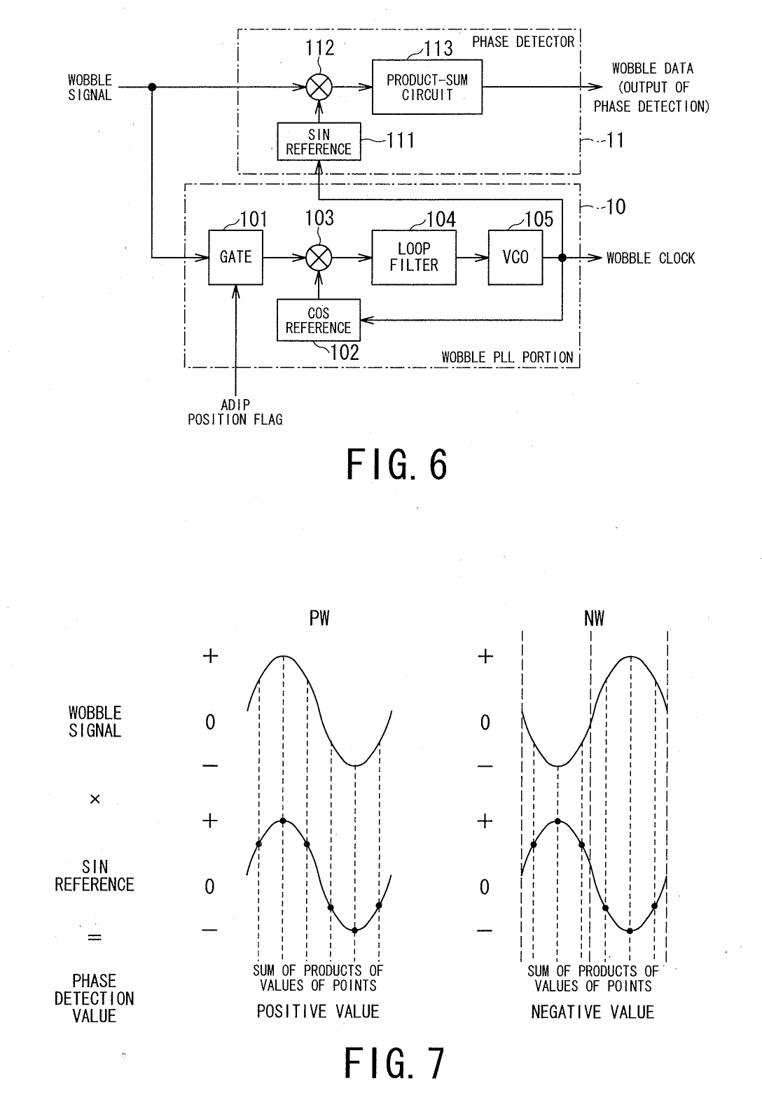

FIG. 6 shows examples of the internal configurations of the phase detector 11 and the wobble PLL portion 10 associated with the phase detector 11.

A phase detector 103 in the wobble PLL portion 10 generates a difference in phase between the wobble signal and a COS reference 102. The phase difference is supplied to a voltage controlled oscillator (VCO) 105 through a loop filter 104 as a control signal. The frequency and phase of the VCO 105 is controlled such that the phase difference between the wobble signal and the COS reference 102 becomes close to zero.

If the phase is locked, the PW is orthogonal to the COS reference 102 (the PW is out of phase with the COS reference 102 by 90°) and the phase difference is substantially equal to zero. A wobble clock generated by the VCO 105 has a frequency equal to that of the wobble signal. The COS reference 102 is generated on the basis of a clock given by multiplying the wobble clock (a multiplier is not shown in FIG. 6).

In the phase detector 11, an SIN reference 111 orthogonal to the COS reference 102 is generated on the basis of the clock given by multiplying the wobble clock. The wobble signal is subjected to the phase detection in a phase detector 112 in the phase detector 11 on the basis of the SIN reference 111.

If the wobble PLL portion 10 is locked, the PW is in phase with the SIN reference 111.

FIG. 7 illustrates a concept of the phase detection of the wobble signal and the SIN reference 111. When the wobble signal is a PW, the wobble signal is in phase with the SIN reference 111 and a sum of products of sampling data (an analog-to-digital conversion circuit is not shown in FIG. 6) in a product-sum circuit 113 results in a positive value (multi-value). In contrast, when the wobble signal is an NW, the wobble signal is out of phase with the SIN reference 111 and a sum of products of the sampling data results in a negative value (multi-value).

The product-sum circuit 113 outputs a multi-value data, which is binarized in conversion into a physical address. The wobble signal on the optical disc 100 is subjected to the phase modulation by using a code sequence in which “0” is allocated to the PW (PW=“0”) and “1” is allocated to the NW (NW=“1”). Accordingly, if the multi-value data output from the product-sum circuit 113 in the phase detector 11 is correctly demodulated, the original code sequence is correctly restored and the physical address information is correctly extracted from the code sequence.

If an output (multi-value) of the phase detection has a sufficiently high SN ratio, the output can be simply sliced with an appropriate threshold to yield binary data. However, if an output (multi-value) of the phase detection has a lower SN ratio, the amplitude of an output of the phase detection greatly varies due to an effect of noises or the likes. As a result, the output cannot be correctly binarized by a simple slicing method and the possibility of misdetection or non-detection of the code sequence is increased.

Accordingly, according to the embodiment of the present invention, a process of yielding an evaluation value indicating how much the code sequence output from the phase detector 11 coincides with the modulation rule used to generate the code sequence (hereinafter referred to as an evaluation-value calculating process) and a process of integrating the yielded evaluation values (hereinafter referred to as an evaluation-value integrating process) are performed so that the original code sequence can be reliably detected even at a lower SN ratio.

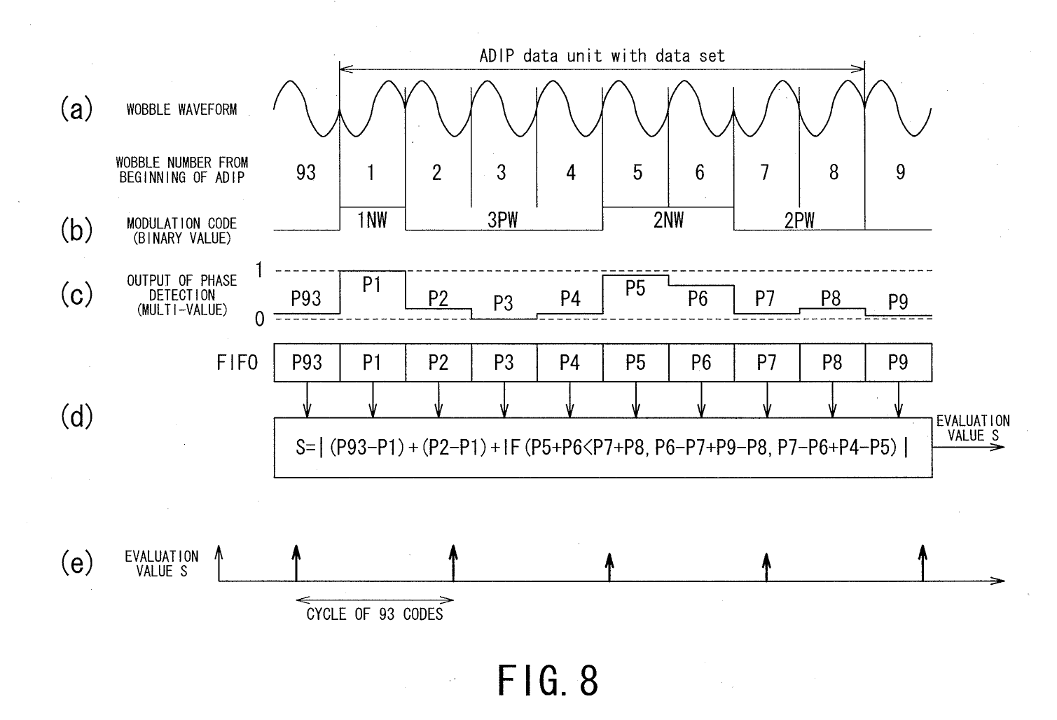

FIG. 8 illustrates an operational concept of the evaluation-value calculating process in detail. An example of the waveform of the wobble signal that is subjected to the phase modulation is shown by (a) in FIG. 8. An example of the code sequence, which is a modulating signal, is shown by (b) in FIG. 8. In (b) in FIG. 8, “0” (monotone) is associated with “PWs” and “1” (modulated) is associated with “NWs”. An example of an output (multi-value) of the phase detection is shown by (c) in FIG. 8.

As described above with reference to FIGS. 3 to 5, the ADIP word including the physical address information includes 51 “data units” and one “sync unit”. Each “data unit” includes 93 wobbles and each wobble (“PW” or “NW”) corresponds to a code unit of “0” or “1”. In other words, each “data unit” is a code sequence including 93 codes. The “data unit” has a cycle of 93 codes (a predetermined repeating cycle).

Referring to FIG. 8, the codes (wobbles) are given numbers from 1 to 93 from the beginning, and the numbers are used to represent the value (multi-value) of the output of the phase detection for every code unit as Pn (n=1 to 93).

The code sequence of each of the “data units” which make up the majority of the ADIP word is characterized by the first eight codes among the 93 codes. Specifically, as shown in FIG. 5B, in the code sequence representing the “data 0”, the first eight codes are “10000011” and the subsequent 83 codes are all “0”.

In contrast, as shown in FIG. 5C, in the code sequence representing the “data 1”, the first eight codes are “10001100” and the subsequent 83 codes are all “0”.

In both of the code sequences, the code (having a number 93) previous to the first eight codes is always equal to “0”.

The ADIP evaluation value calculator 13 calculates an evaluation value S on the basis of the characteristic of the first eight codes.

Specifically, the outputs of the phase detection are sequentially supplied to the FIFO memory 12 in units of codes, and the ADIP evaluation value calculator 13 calculates the evaluation value S for each output from the FIFO memory 12 (refer to (d) in FIG. 8). The evaluation value S is calculated, for example, according to Equation (1):

S=|(P93−P1)+(P2−P1)+IF(P5+P6<P7+P8,P6−P7+P9−P8,P7−P6+P4−P5)| (1)

wherein IF(A<B, C, D)=C A<B and
IF(A<B, C, D)=D A≧B

In Equation (1), the first and second terms, (P93−P1)+(P2−P1), form an addition and subtraction equation used for adding a difference between the outputs of the phase detection before and at a point where the code varies to a difference between the outputs of the phase detection after and at the point where the code varies. This addition and subtraction equation is based on the modulation rule in which the first code is always equal to “1” and the codes before and after the first code are equal to “0”. Provided that the outputs of the phase detection in an ideal state in which no noise is produced are P93=0.0, P1=1.0, and P2=0.0, the sum of the first and second terms is equal to “−2.0”.

The third term of Equation (1) is a logical expression. A logical value of the logical expression is given by differentiating cases where the code sequence represents the “data 0” from cases where the code sequence represents the “data 1” and calculating a sum of a difference between the outputs of the phase detection before and after a point where the code varies and a difference between the outputs of the phase detection before and after a point where the codes varies in each case. FIG. 8 shows a case where the code sequence represents the “data 1”. In this case, the logical expression “P5+P6<P7+P8” is “false” and the third term is equal to “P7−P6+P4−P5”. In the ideal state in which no noise is produced, P4=0.0, P5=1.0, P6=1.0, and P7=0.0 and the value of the third term is equal to “−2.0”.

As a result, the evaluation value S is equal to “4.0”, which is the absolute value of “−4.0”. Equation (1) is given by representing the modulation rule of 10 codes (P93 to P9), which include the first eight codes in the code sequence, one code previous to the eight codes, and one code subsequent to the eight codes, by using the addition and subtraction equation and the logical expression. The evaluation value S is an index indicating how much the code sequence sequentially input in units of codes coincides with the modulation rule. In other words, the evaluation value S is an index representing how much the code sequence is close to the ADIP (the first eight codes).

A time when the evaluation value S takes the maximum value indicates a time when the “ADIP” (the first eight codes) is input in the ADIP evaluation value calculator 13. As shown by (e) in FIG. 8, a reference position of each code sequence of the 93 codes can be determined on the basis of a position where the evaluation value S takes the maximum value (the maximum value “4.0” in the example in FIG. 8). One “sync unit” among the 52 units does not take the maximum value because the “sync” unit” does not follow the modulation rule represented by Equation (1) while each “data unit” takes the maximum value in a cycle of 93 codes.

A limited condition may be added to the modulation rule in Equation (1). For example, a condition in which “the average value of the P2, P3, and P4 is close to zero” may be added to the modulation rule. A condition in which “the difference between the P5+P6 and the P7+P8 is close to two” may be added to the modulation rule. A condition in which “either of the P5+P6 and the P7+P8 is close to two” may be added to the modulation rule.

The addition of such a limited condition increases the arithmetic processing (arithmetic circuit) in size but improves the degree indicating how much the code sequence is close to the ADIP, thus improving the SN ratio of the evaluation value S.

As described above, the detection of the maximum value of the evaluation value S output from the ADIP evaluation value calculator 13 allows the presence of the code sequence and the reference position of the code sequence to be detected. However, it is not necessarily sufficient to use this method if the evaluation value S has a lower SN ratio.

Accordingly, according to the embodiments of the present invention, the wobble signal demodulation unit 20 further includes the integrator 14 used for integrating the output from the ADIP evaluation value calculator 13 in order to improve the SN ratio of the evaluation value S.

The maximum value of the evaluation value S appear in a cycle of 93 codes, as shown by (e) in FIG. 8. By using this periodicity, a cyclic integrator that has a cycle of 93 codes may be used as the integrator 14.

The cyclic integrator can be used to integrate the evaluation values S sequentially supplied from ADIP evaluation value calculator 13 in units of codes at the same code position, thus improving the SN ratio.

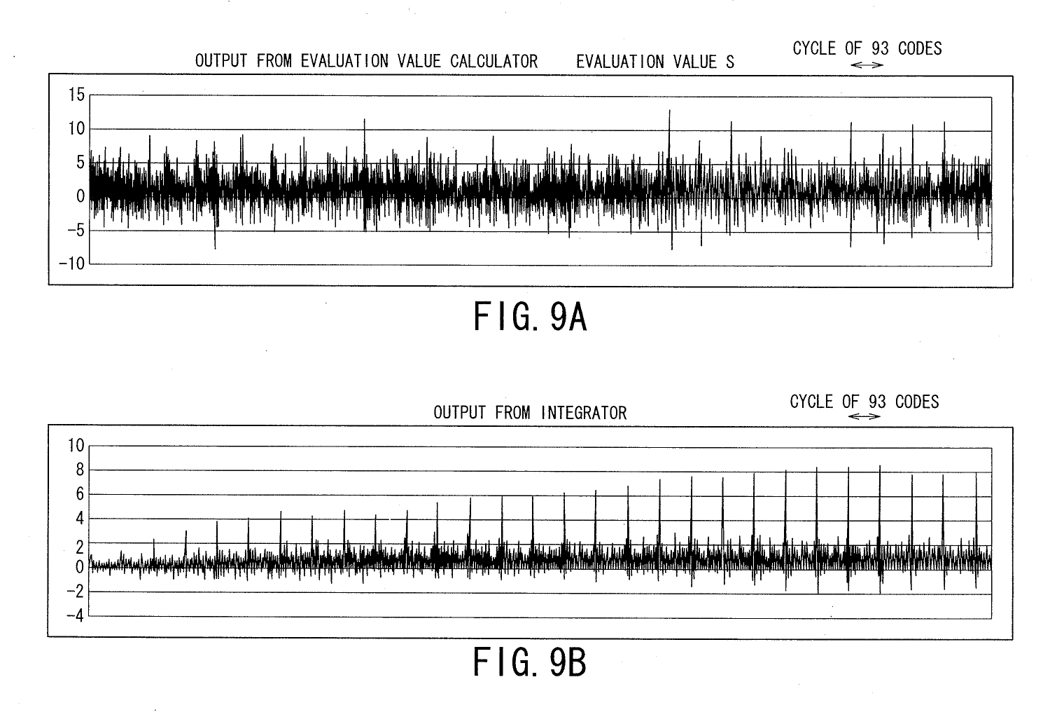

FIGS. 9A and 9B illustrate an effect the integration in the integrator 14. FIG. 9A shows a waveform appearing when the output signal (the evaluation value S before the integration) from the ADIP evaluation value calculator 13 has a lower SN ratio. Many peaks of the evaluation value S are buried in the noises.

FIG. 9B shows a result of the integration of the evaluation value S having the lower SN ratio. As apparent from FIG. 9B, the SN ratio of the evaluation value S is greatly improved with the increasing number of times of integration and the peak values of the evaluation value S, showing the positions of the ADIP, are isolated from the surrounding noises.

Although the integration process in FIG. 9B is performed by using a weighted integrator as the integrator 14, an integration method using a simple addition may be used. However, if the integrator 14 adopts the integration method using a simple addition, an increase in the number of times of L integration leads to saturation. Accordingly, a process of halving the integration values of all the 93 codes is added before the integration value of any of the 93 codes reaches a predetermined value or before an overflow occurs in order to avoid the saturation. This method can be realized by using an addition and a bit shift process, so that the configuration of the integrator 14 can be simplified.

Although a larger time constant of the integrator 14 has an effect on the improvement of the SN ratio, it takes a longer time to detect the ADIP with the time constant being set to a value that is too large. In contrast, the time constant that is too small quickens the detection of the ADIP but lessens the effect of improving the SN ratio of the evaluation value S.

Accordingly, it is preferred that the time constant of the integrator 14 be set to a value that does not greatly exceed a time necessary for one ADIP word (refer to FIG. 3) to appear.

The output from the integrator 14 is supplied to the synchronous detector 16. The synchronous detector 16 detects the position of a cell (code unit) having the maximum value in the cyclic period of the integrator 14 and determines the position of the ADIP (the reference position of the code sequence) on the basis of the detected position.

In the detection of the maximum value in the synchronous detector 16, the maximum value may be simply detected after the integration is performed an appropriate number of times or a threshold value may be determined on the basis of the peak values for every cycle to select the maximum value from among the values of the cells exceeding the threshold value.

The ADIP flywheel counter 17 is set on the basis of the reference position of the ADIP, determined by the synchronous detector 16. The ADIP flywheel counter 17, which has a cycle of 93 codes, supplies a timing corresponding to the position of the data 0” or the “data 1” in the code sequence having a cycle of 93 codes to the physical address extractor 18.

The physical address extractor 18 extracts the “data 0” or the “data 1” included in the output of the phase detection on the basis of the timing to edit the physical address information.

The synchronous detector 16 may generate a flag indicating the positions of the first eight codes (ADIP position) in the code sequence of 93 codes and may supply this flag to the wobble PLL portion 10 for masking in the wobble PLL portion 10.

The wobble PLL portion 10 performs phase locking in the PWs (non-modulation area) of dominant numbers (85 codes) among the 93 codes. However, the wobble PLL portion 10 can be subjected to disturbance in the modulation area (the eight codes at the ADIP position). Accordingly, the above flag may be used to mask the wobble signals supplied to the wobble PLL portion 10 (refer to a gate 101 in FIG. 6) to stabilize the phase locking process.

Although the evaluation-value calculating process is first performed for the output of the phase detection and the evaluation-value integrating process is then performed in the above embodiment of the present invention, the order of the processes may be inverted.

Specifically, the integrator 14 having a cycle of 93 codes may be used to perform the integration process for the output of the phase detection and the evaluation-value calculating process may be performed for the integration result to determine the ADIP position.

With this method, since the “data 0” and the “data 1” have different patterns in the area of the last four codes among the first eight codes, the integration process smoothes the patterns and it is not possible to expect the effect of the integration. However, since the first four codes among the first eight codes have a common pattern “1000” in both of the “data 0” and the “data 1”, the SN ratio of the output of the phase detection is improved owing to the effect of the integration.

In the succeeding evaluation-value calculating process, the evaluation value S reflecting the modulation rule of the first four codes (“1000”) is calculated. For example, the evaluation value S is calculated by the addition of the first and second terms in Equation (1). The synchronous detector 16 detects the maximum value of the evaluation value S from among the 93 codes to determine the ADIP position. The subsequent process is similar to the one in the embodiments of the present invention described above.

As described above, according to the optical disc apparatus 1 and the method of processing synchronization signals for the optical disc apparatus 1 in the embodiments of the present invention, it is possible to reduce misdetection or non-detection of synchronization signals even if a wobble signal reproduced from the optical disc has a lower SN ratio to realize stable synchronous detection.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc apparatus comprising:
a reproduction unit configured to reproduce a wobble signal on an optical disc, the wobble signal having physical address information subjected to phase modulation by using a code sequence that has a predetermined cycle and that is subjected to code modulation in accordance with a modulation rule common to the cycles;
a phase detection unit configured to perform phase detection to the reproduced wobble signal to demodulate the code sequence;
an evaluation value calculating unit configured to sequentially calculate an evaluation value indicating how much the code sequence coincides with the modulation rule in units of codes in the code sequence;
an integrator configured to cyclically integrate the evaluation value output from the evaluation value calculating unit in units of codes in the cycle; and
a synchronous detection unit configured to detect the presence of the code sequence and a reference position of the code sequence from the evaluation value integrated by the integrator.

2. The optical disc apparatus according to claim 1, wherein the code sequence represents data including a combination of a code “0” and a code “1”, and wherein the modulation rule is defined by the data and the combination of the codes.

3. The optical disc apparatus according to claim 2, wherein the code sequence includes N-number of codes and the predetermined cycle is a cycle of the N-number codes, and wherein the evaluation value is calculated by an addition and subtraction equation or a logical expression of p(n) (n=1 to N) on the basis of the modulation rule where the p(n) denotes the value of each output of the phase detection, corresponding to the code “0” or “1”.

4. The optical disc apparatus according to claim 3, wherein the optical disc comprises a DVD+R or a DVD+RW format and the “N” is equal to 93.

5. The optical disc apparatus according to claim 1, wherein the integrator is configured so as to halve all the values of the integrator if any of the integration values exceeds a predetermined value.

6. The optical disc apparatus according to claim 1, wherein a time constant of the integrator is set within a range that does not exceed a reproduction time of one piece of the physical address information represented by multiple code sequences.

7. The optical disc apparatus according to claim 1, further comprising an address extraction unit that extracts the physical address information from the output from the phase detection unit on the basis of the reference position of the code sequence output from the synchronous detection unit.

8. The optical disc apparatus according to claim 1, wherein the code sequence includes a modulation area indicating predetermined data by using the code “0” and the code “1” and a non-modulation area in which the code “0” is repeated, and wherein a flag indicating the period of the modulation area is generated on the basis of the reference position of the code sequence, the wobble signal is masked by using the flag, and the phase detection is performed by a phase locked loop process using the masked wobble signal.

9. An optical disc apparatus comprising:
a reproduction unit configured to reproduce a wobble signal on an optical disc, the wobble signal having physical address information subjected to phase modulation by using a code sequence that has a predetermined cycle and that is subjected to code modulation in accordance with a modulation rule common to the cycles;
a phase detection unit configured to perform phase detection to the reproduced wobble signal to demodulate the code sequence;
an integrator configured to cyclically integrate the phase detection value output from the phase detection unit in units of codes in the cycle;
an evaluation value calculating unit configured to sequentially calculate an evaluation value indicating how much the code sequence coincides with the modulation rule in units of codes in the code sequence for the integrated phase detection value; and
a synchronous detection unit configured to detect the presence of the code sequence and a reference position of the code sequence from the evaluation value calculated by the evaluation value calculating unit.

10. A method of processing synchronization signals for an optical disc apparatus, the method comprising:
reproducing a wobble signal on an optical disc, the wobble signal having physical address information subjected to phase modulation by using a code sequence that has a predetermined cycle and that is subjected to code modulation in accordance with a modulation rule common to the cycles;
performing phase detection to the reproduced wobble signal to demodulate the code sequence;
sequentially calculating an evaluation value indicating how much the code sequence coincides with the modulation rule in units of codes in the code sequence;
cyclically integrating the evaluation value in the cycle; and
detecting the presence of the code sequence and a reference position of the code sequence from the integrated evaluation value.

11. The method of processing synchronization signals for an optical disc apparatus according to claim 10, wherein the code sequence represents data including a combination of a code “0” and a code “1”, and wherein the modulation rule is defined by the data and the combination of the codes.

12. The method of processing synchronization signals for an optical disc apparatus according to claim 11, wherein the code sequence includes N-number of codes and the predetermined cycle is a cycle of the N-number codes, and wherein the evaluation value is calculated by an addition and subtraction equation or a logical expression of p(n) (n=1 to N) on the basis of the modulation rule where the p(n) denotes the value of each output of the phase detection, corresponding to the code “0” or “1”.

13. The method of processing synchronization signals for an optical disc apparatus according to claim 12, wherein the optical disc comprises a DVD+R or a DVD+RW format and the “N” is equal to 93.

14. The method of processing synchronization signals for an optical disc apparatus according to claim 10, wherein the integrator is configured so as to halve all the values of the integrator if any of the integration values exceeds a predetermined value.

15. The method of processing synchronization signals for an optical disc apparatus according to claim 10, wherein a time constant of the integrator is set within a range that does not exceed a reproduction time of one piece of the physical address information represented by multiple code sequences.

16. The method of processing synchronization signals for an optical disc apparatus according to claim 10, wherein the physical address information is extracted from the output of the phase detection on the basis of the reference position of the code sequence.

17. The method of processing synchronization signals for an optical disc apparatus according to claim 10, wherein the code sequence includes a modulation area indicating predetermined data by using the code “0” and the “1” and a non-modulation area in which the code “0” is repeated, and wherein a flag indicating the period of the modulation area is generated on the basis of the reference position of the code sequence, the wobble signal is masked by using the flag, and the phase detection is performed by a phase locked loop process using the masked wobble signal.

18. A method of processing synchronization signals for an optical disc apparatus, the method comprising:
reproducing a wobble signal on an optical disc, the wobble signal having physical address information subjected to phase modulation by using a code sequence that has a predetermined cycle and that is subjected to code modulation in accordance with a modulation rule common to the cycles;
performing phase detection to the reproduced wobble signal to demodulate the code sequence;
cyclically integrating the demodulated phase detection value in the cycle;
sequentially calculating an evaluation value indicating how much the code sequence coincides with the modulation rule in units of codes in the code sequence for the integrated phase detection value; and
detecting the presence of the code sequence and a reference position of the code sequence from the evaluation value.
